(19) United States
(12) Patent Application Publication
(10) Pub. No.: US 2009/0057293 A1
(43) Pub. Date: Mar. 5, 2009

(54) FOOD HOLDING OVEN AND TRAY WITH INFRARED HEAT WEIGHTED AROUND THE TRAY PERIPHERY

(76) Inventors: Jeff SCHROEDER, Lake Zurich, IL (US); Loren VELTROP, Chicago, IL (US)

Correspondence Address: LADAS & PARRY LLP, 224 SOUTH MICHIGAN AVENUE, SUITE 1600, CHICAGO, IL, 60604, US

(21) Appl. No.: 11/850,071

(22) Filed: Sep. 5, 2007

(51) Int. Cl. A21B 1/00

(52) U.S. Cl. 219/411

(57) ABSTRACT

A food holding oven holds pre-cooked food at a selected temperature by heating the food in a food-holding tray using infrared energy obtained from a multi-layer planar infrared energy source above the food. The infrared emitted from the planar IR source is produced by electrically heated windings in either a boustrophedonic or crenellated pattern, the loops and crenellations of which are more closely spaced near the edge of the heater than they are away from edges of the heater. The IR from the heater is directed toward the tray such that there is more IR directed at the tray edges than is directed toward the tray interior regions.

### FIELD OF THE INVENTION

This invention relates to the field of food preparation. More particularly. this invention relates to an apparatus and method for maintaining in a ready-to-serve condition cooked food portions contained in a food tray, wherein a freestanding cover is used to cover the food trays.

### DESCRIPTION OF RELATED ART

In many restaurants, some food items are cooked in advance of when they are ordered by or served to a customer. Examples of such food items can include sandwiches and sandwich fillings like cooked eggs, hamburger patties, chicken nuggets or French fries. Such previously cooked food items are often maintained in a ready-to-use or ready-to-serve condition until they are served to the customer. This typically involves maintaining the previously cooked food items at a serving temperature in the range of from about 145 degrees F. to about 200 degrees F., depending on the food item.

Various food warming devices have been developed to maintain previously cooked food items at a desired serving temperature and are sometimes referred to as staging cabinets, holding cabinets, warming cabinets or food holding or food warming ovens. One challenge associated with food warming ovens is being able to preserve the flavor, appearance, and texture of previously-cooked food items while the items are being maintained at a desired serving temperature such that when a food item is served to or purchased by a customer, the customer will be pleased with the condition of the food item.

Fried foods in particular tend to become soggy when they are kept warm for extended periods of time. A commonly used method of warming fried foods is to heat them with infrared because it provides a relatively dry heat that can also be applied quickly. Unfortunately, prior art food holding ovens that use infrared lamps or bulbs do not and cannot evenly distribute IR energy over trays in which pre-cooked fried foods are kept until they are served because the bulbs or lamps use parabolic reflectors behind an IR-emitting filament.

FIG. 1 depicts a prior art food holding oven 10, which provides infrared (IR) energy 12 to pre-cooked food 14 in a holding tray 16 that rests atop a base cabinet 18. IR energy supplied by one or more incandescent lamps 20 that heats food 14 lying in the holding tray 16 as well as food that has been packaged and stacked for sale and which is held in holding racks 17 located adjacent the holding tray 16. The lamps 20 are mounted in a hood 22 that is located above the tray 16 by a separation distance 24 that provides easy access to the tray 16 and its contents 14. The separation distance 24 is typically about fourteen to twenty four inches.

An unfortunate consequence of heating food 14 using IR energy 12 supplied by lamps 20 is that the IR energy 12 emitted from a bulb or lamp 20 is neither focused nor uniform. The IR 12 emitted from a lamp 20 is cone-shaped and therefore inherently non-uniform, due in large part to the fact that lamps use a parabolic reflector. Areas of the tray 18 directly below a lamp 20 will receive more IR energy than will perimeter regions 22. Because the IR energy 12 output from a lamp is non-uniform relative to the lamp central axis of rotation, portions of the tray near its peripheral or perimeter edges 22 tend to be substantially cooler than the center area 18.

### BRIEF DESCRIPTION OF THE DRAWINGS

FIG. 1 depicts a prior art food holding oven, which provides infrared energy from incandescent lamps or bulbs;

FIG. 2 depicts a front view of a food holding oven that provides infrared energy that is weighted around the periphery of a food holding tray;

FIG. 3 depicts a side view of the oven shown in FIG. 2;

FIG. 4 depicts an exploded view of the food holding oven shown in FIG. 2 and FIG. 3 and depicts the infrared heating source used therein;

FIG. 5 depicts a plan view of one embodiment of a planar heating element that provides peripherally-weighted infrared; and

FIG. 6 depicts a plan view of a second embodiment of a planar heating element that provides peripherally-weighted infrared.

### DETAILED DESCRIPTION

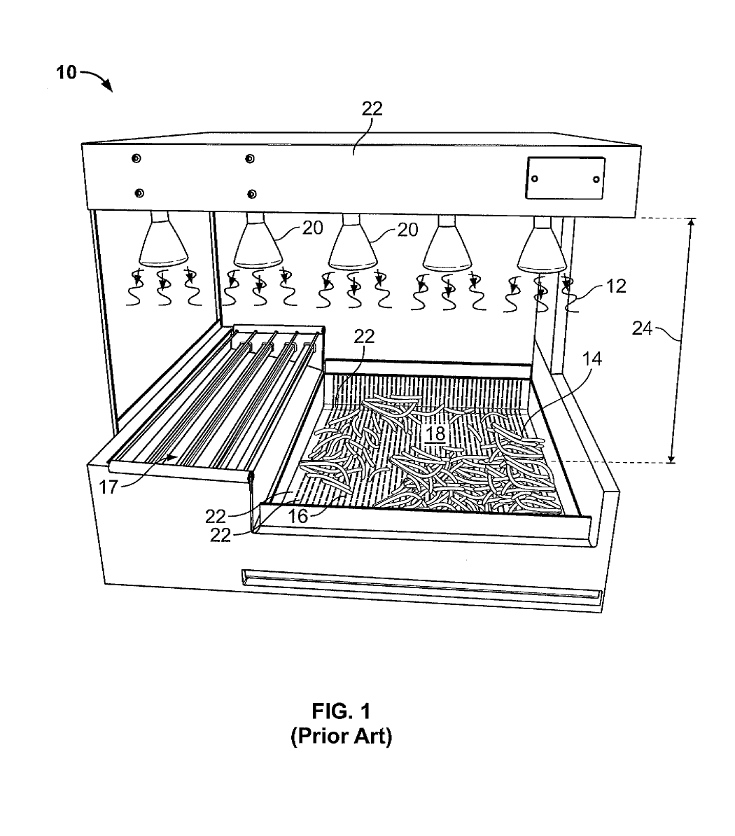

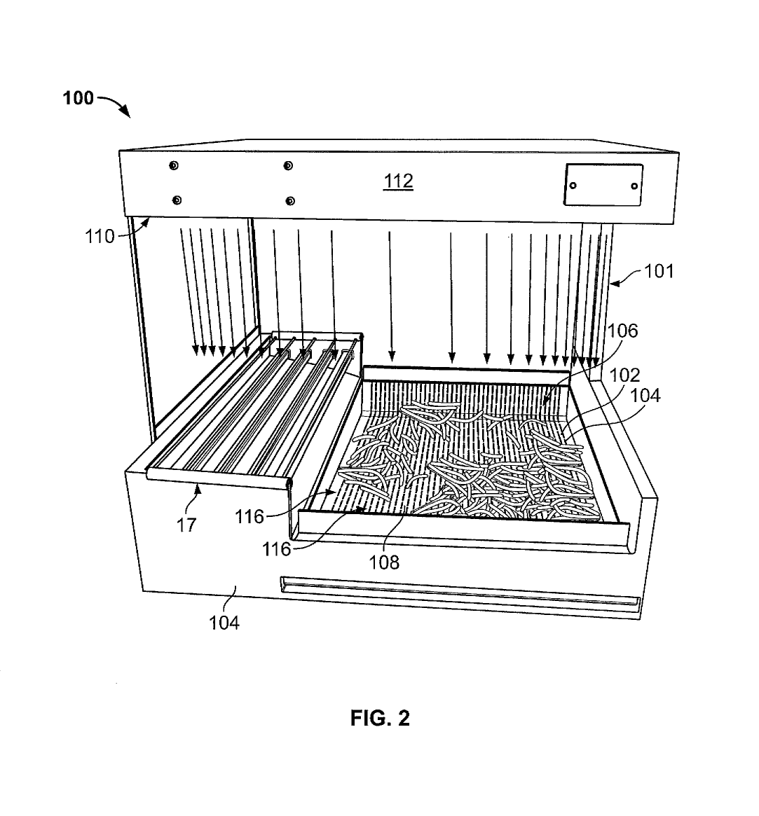

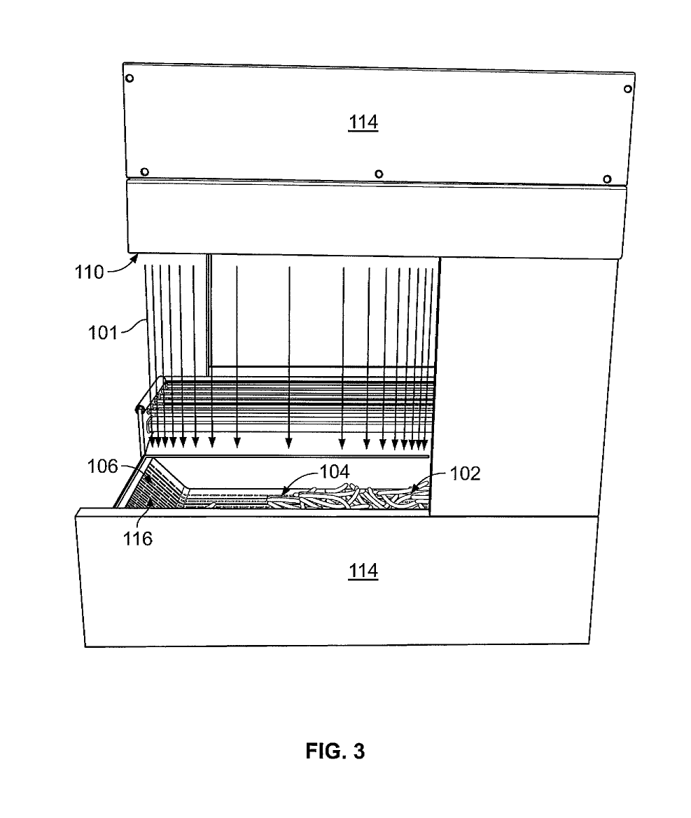

FIG. 2 shows a front view of a food holding 100 oven for holding previously cooked food at a selected temperature. As with the prior art oven 10 depicted in FIG. 1, the food holding oven 100 shown in FIG. 2 also has a holding tray 102 that rests atop a base cabinet 104. FIG. 3 is a right side view of the food holding oven 100.

As can be seen in FIG. 2, the holding tray 102 has a substantially planar bottom 104 and inclined side walls 106. The tray also includes several slots or holes 108 that extend completely through the tray, which allow cooking oil to drain off and which prevent seasonings from accumulating in the tray 102.

Unlike the prior art oven 10 shown in FIG. 1, the food holding oven 100 in FIG. 2 differs from the prior art food holding ovens by keeping previously-cooked food warm and ready to serve using IR energy 101 emitted from a rectangular and planar infrared heater 110, which is not shown in FIG. 2 or FIG. 3 because it is located behind a front trim panel 112 in FIG. 2 and a side trim panel 114 in FIG. 3.

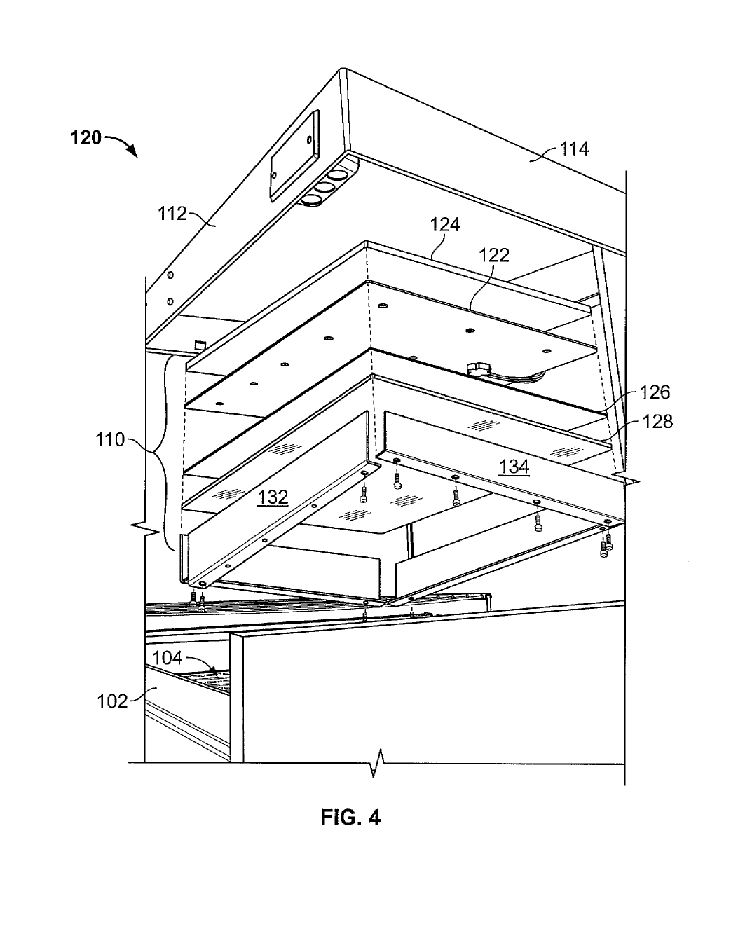

FIG. 4 shows the location and attachment of the planar infrared heater 110 to the oven 100. As can be seen in FIGS. 2, 3 and 4, the planar heater 110 is substantially parallel to the planar bottom 104 of the tray 102 and spaced above the bottom 14 of the tray 102 by a predetermined distance of about fourteen to twenty four inches. Unlike bulbs or lamps, the heater 110 directs infrared energy 101 substantially straight down so that relatively little IR 101 is directed outside of where it is needed, i.e., within the tray 102. More importantly, as shown in FIG. 2 and FIG. 3, the heater 110 is sized, shaped and arranged to concentrate the IR 101 that it emits around the periphery 116 of the tray 102 in order to supply more heat to the tray 102 where the heat is lost most rapidly, i.e., at the edges of the tray.

Experimentation shows that directing IR 101 straight down and weighting or concentrating the IR so that the IR energy density adjacent to the edges of the tray 102 is greater than the IR energy density within the interior of the tray, maintains temperatures within the tray 102 more uniformly than prior art lamps that emits IR in a diverging, cone-shaped pattern, which also tends to be concentrated near the center of the tray 102 as shown in FIG. 1. Stated another way, by directing IR energy essentially straight down from a planar heater 110, which also concentrates the downwardly-directed IR 101 toward the edges 116 of the tray 102 such that there is a preponderance of IR directed toward the peripheral edges of the tray as compared to the IR directed to the middle of the tray, which yields more uniform food heating through-out the tray 102 than is possible using point-sources of IR, like IR heating lamps.

It is believed that the peripherally-weighted, downwardly-directed IR 101 compensates for heat lost from the tray around its edges and into surrounding room air. By delivering more IR to where it is being lost from the interior regions, the downwardly-directed IR from a planar heater is much better able to provide and maintain a uniform temperature in the tray 14.

In FIG. 4, an electrically resistive heating element 122 is sandwiched between a mechanically supportive metal substrate 124, adjacent to which is a thin, thermally resistive layer (not shown), and an IR transmissive front layer 126, which can include glass and/or metal. An optional second IR transmissive protective glass layer 128, readily cleaned of grease and other cooking by-products, acts to protect the layers 126, 124 and 122 behind the glass layer 128. In one embodiment, the second IR transmissive layer 128 is constructed of an IR-transmissive but ultraviolet-filtering glass, which acts to block or suppress the transmission of harmful ultraviolet (UV) energy, such as the UV commonly referred to as UV “A” and UV “B” rays, that might be generated by the resistive heating element 122. In such embodiment, the planar heater 110 is considered to be a reduced UV or filtered UV heater.

In the embodiment shown in FIG. 4, the layers 122, 124, 126 and the optional protective layer 128, if provided, are separate or discrete components that are assembled together and held in place mechanically in the hood 120 by stainless sheet metal brackets 132 and 134, which are themselves riveted or bolted to the oven hood 120. In another embodiment, the layers 122, 124, 126 and protective layer 128, if provided, are permanently bonded together by an appropriate adhesive such that the several layers form a single, monolithic component.

When the heater 110 is constructed from separate elements that are mechanically assembled together, the overall thickness of the assembly heater element 110 ranges from ⅛ inch to up to inches. When the heater 110 is constructed by laminating the layers together, the overall thickness of the heater ranges from one-quarter to two inches.

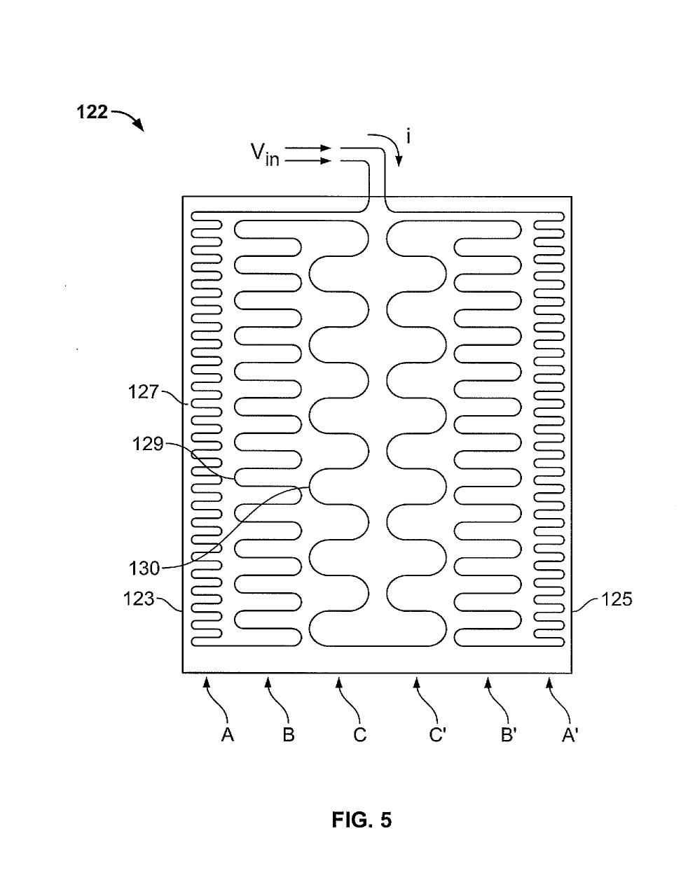

FIG. 5 is a plan view of one embodiment of the heating element 122 used in the planar heater 110 shown in FIGS. 2, 3 and 4. FIG. 5 depicts one way that electrically resistive heating wire or other electrically resistive material within the heater element 122 can be arranged to provide downwardly-directed IR that is also concentrated around the periphery of the heater 110 and hence concentrated around the periphery of the tray 102. In FIG. 5, a length of electrically resistive wire 118 is attached to a thermally non-conductive and electrically non-conductive substrate 120. The wire 118 is arranged in boustrophedonic rows, (or rows of boustrophedons) denominated from left to right in the figure as A, B, C and C′, B′ and A′.

The two outside rows, A and A′, have a first boustrophedonic pattern that extends along opposing sides or edges 123 & 125 of the substrate 120. The loops or rows 127 of the two outside rows A and A′ are both more numerous and more closely spaced to each other than are the loops 129, 130 of the second and inside boustrophedonic rows, B and B′ and which have a second boustrophedonic pattern. Similarly, the first inside rows B and B′ have a boustrophedonic pattern the loops or rows of which are more numerous and more closely spaced than the second inside rows C and C′. The winding patterns, i.e., loop spacing, of the row pairs A-A′, B-B′ and C-C′ are thus different in that the loops 127 in the first row pair A-A′ are spaced more closely to each other than are the loops 129, 130 of the other two rows.

An input voltage, Vᵢₙ, which can be either an alternating current or a direct current, is applied to the ends of a single length of electrically resistive material referred to here as a wire. Since the wire forming the loops is a single length of wire, the current, i, that flows through the rows A, B, C and C′, B′ and A′ is the same everywhere along the length of the wire. And, since the electrical resistance per unit length of the wire used to form the loops is constant, the emitted IR per unit area of the heating element 122 will be greater in areas where the loops 127 are more closely-spaced together than where the loops 129, 130 are farther apart.

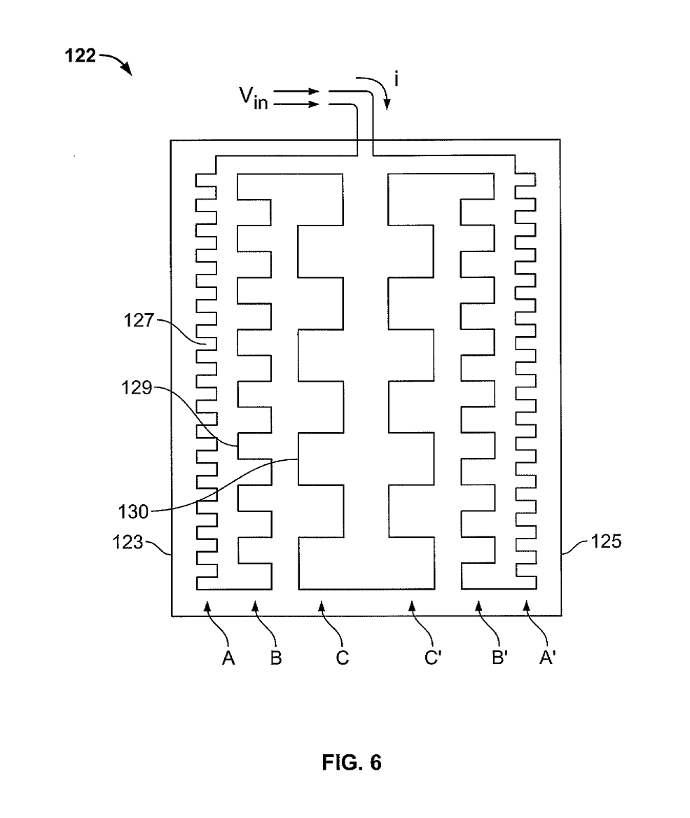

If the IR 101 emitted from each row is considered to be emitted in rays or lines, as depicted in FIG. 2 and which is identified by reference numeral 101. As shown in FIG. 2, the more closely-spaced outside rows A and A′ immediately adjacent to the edges 123, 125, will emit IR rays that are more dense per unit area or more “numerous” than the IR rays emitted from the interior rows B and B′ that are considered to be interior rows with respect to the edges 123, 125. Similarly, the rows B and B′ will emit more IR than the interior rows C and C′. It can thus be seen that by spacing the boustrophedonic heating loops more closely together, the pattern of the IR emitted from the heater can be pre-determined to be greater at the periphery of the heating element 110 than in or towards the middle regions of the element 110. In other words, a preponderance of the total amount of IR emitted from the heater 110 will be emitted from the outer rows A and A′ and which will correspondingly be directed to the edge of the tray, i.e., more IR will be directed at surfaces below the loops (or crenellations in FIG. 6) that are more closely spaced together.

FIG. 6 is a plan view of a second embodiment of the heater 110, depicting another way that electrically heating elements within the heater can be arranged to provide downwardly-directed IR that is also concentrated around the periphery of the heater 110 and hence concentrated around the periphery of the tray 102. In FIG. 6, a length of electrically resistive wire 118 is attached to a substrate 120 in crenellated rows (or rows of crenellations) denominated from left to right as A, B, C and C′, B′ and A′.

The two outside rows, A and A′ and which are immediately adjacent to the opposing edges 123, 125 have a saw-tooth or crenellated pattern, the individual crenellations of which are more numerous and more closely spaced than are the crenellations of the first inside rows, B and B′. Similarly, the first inside rows B and B′ have a crenellated patter, the crenellations of which are more numerous and more closely spaced than the second inside rows C and C′. As with the embodiment shown in FIG. 5, in FIG. 6, the more closely-spaced crenellations of outside rows A and A′ will emit IR rays that are more numerous than the IR rays emitted from the interior rows B and B′ as well as C and C′. By appropriately sizing, shaping and arranging the loops or crenellations, the planar heater 110 can thus generate IR that is directed substantially straight down albeit with an energy density that is significantly greater around the periphery of the heater 110 than within its interior.

In one embodiment, the heater 110 used a planar heater with eight rows of crenellations. The crenellations in the rows A and A′ adjacent to the substrate edges 123, 125 grew increasingly more separated as the rows B, B′ and C, C′ get farther from substrate's edges 123, 125. In an alternate embodiment, the heater could also use eight boustrophedonic rows.

In one embodiment, the planar heating element was implemented using tungsten supported by a fiberglass screen and a non-metallic, thermally insulative rigid fibrous material. The tungsten can be an etched foil or a length of tungsten wire.

Those of ordinary skill in the art will recognize that the wavelength of IR emitted from a body varies inversely with the body's temperature. Higher temperatures generate shorter wavelengths. The wavelength of the emitted IR 101 can therefore be controlled by controlling the current through the windings. Relatively deep-penetrating and intense short wavelength IR is generated at higher temperatures, which require more current to generate than will longer wavelength IR that is less-penetrating and less intense. The emitted IR wavelength can thus be varied in the planar heater 110 by varying the current through the electrically-resistive material from which the heating elements are formed.

The peripherally-weighted IR is produced by concentrating heating coils close to the edges of the heater 110 such that the density of electrically-resistive heating coil material proximate to the heater's edges is greater than the density or amount of the material near the center of the heater 110. In other words, concentrating heater windings such that more IR is generated near the edges of the planar heater 110 will cause the IR emitted per unit area to be greater near the edges than it will be away from the edges.

The foregoing description is for purposes of illustration only. The true scope of the invention is defined by the appurtenant claims.

What is claimed is:

1. A food holding oven for heating previously cooked food, the food holding oven comprising:
a base;
a food holding tray supported by said base, the food holding tray having four sides that extend above a perforated planar bottom;
a planar infrared energy source located above the food holding tray at a predetermined distance from the planar bottom, the planar infrared energy source being substantially parallel to the planar bottom and directing infrared energy downwardly in a predetermined emission pattern by which a larger amount of infrared energy emitted from the planar infrared energy source is directed to the periphery of the food holding tray than is directed to the interior of the food holding tray.

2. The food holding oven of claim 1, wherein the planar infrared energy source is comprised of a plurality of layers, a first layer being a support layer, a second layer over the first layer and comprised of a length of electrically-resistive material supported on a rectangular and non-conductive substrate, a third layer being an IR transmissive layer that is over the second layer.

3. The food holding oven of claim 1, wherein the planar infrared energy source is comprised of a length of electrically-resistive material supported on a rectangular and non-conductive substrate, the electrically-resistive material having at least one boustrophedonic pattern that is adjacent to and which extends along at least two opposing sides of the substrate.

4. The food holding oven of claim 1, wherein planar infrared energy source is comprised of a length of electrically-resistive material supported on a rectangular and non-conductive substrate, the electrically-resistive material having a plurality of rows, each of which is formed in a boustrophedonic pattern.

5. The food holding oven of claim 4, wherein the plurality of boustrophedonic rows include at least one row adjacent a side of the substrate, the loops of which are spaced more closely to each other than the loops of a second boustrophedonic row adjacent the first row.

6. The food holding oven of claim 1, wherein the planar infrared energy source is comprised of a length of electrically-resistive material supported on a rectangular and non-conductive substrate, the electrically-resistive material having at least one crenellated pattern the crenellations of which have a first spacing between them and which extend along at least one side of the substrate.

7. The food holding oven of claim 6, wherein the planar infrared energy source is comprised of a length of electrically-resistive material supported on a rectangular and non-conductive substrate, the electrically-resistive material having a plurality of rows, each of which is formed in a crenellated pattern.

8. The food holding oven of claim 7, wherein the plurality of crenellated rows include at least one row adjacent a side of the substrate, the crenellations of which are spaced more closely to each other than the crenellations of a second crenellated row adjacent the first row.

9. The food holding oven of claim 1, wherein the density of the infrared energy directed at the center of the food holding tray is less than the density of the infrared energy directed toward the periphery of the food holding tray.

10. The food holding oven of claim 1, wherein the planar infrared energy source includes a UV-suppressive filter.

11. The food holding oven of claim 1, wherein the planar infrared energy source is a reduced UV heater.

12. The food holding oven of claim 1, wherein the food holding tray is stainless steel.

13. A food holding oven comprising:
a planar infrared energy source comprised of a planar infrared heater supported above the food, the planar infrared heater being comprised of a non-conductive substrate supporting an electrically-resistive material formed into a plurality of boustrophedonic rows that are parallel to each other and which extend across the substrate, the infrared energy emitted from the planar infrared energy source being greater along the edges of the substrate than it is away from the edges of the substrate.

14. The food holding oven of claim 13, wherein the planar infrared energy source is comprised of a plurality of layers, a first layer being a support layer, a second layer over the first layer generating IR and comprised of a length of electrically-resistive material supported on a rectangular and non-conductive substrate, a third layer being an IR transmissive layer that is over the second layer.

15. The food holding oven of claim 13, wherein the loops of the boustrophedonic rows adjacent edges of the substrate are more numerous and closer to each other than are the boustrophedonic rows away from the substrate edges.

16. The food holding oven of claim 13, wherein the planar infrared heater is comprised of eight parallel boustrophedonic rows.

17. The food holding oven of claim 13, wherein the planar infrared energy source includes a UV-suppressive filter.

18. The food holding oven of claim 13, wherein the planar infrared energy source is a reduced UV heater.

19. A food holding oven comprising:
a planar infrared energy source comprised of a planar infrared heater supported above the food, the planar infrared heater being comprised of a non-conductive substrate supporting an electrically-resistive material formed into a plurality of crenellated rows that are parallel to each other and which extend across the substrate, the infrared energy emitted from the planar infrared energy source being greater along the edges of the substrate than it is away from the edges of the substrate.

20. The food holding oven of claim 19, wherein the planar infrared energy source is comprised of a plurality of layers, a first layer being a support layer, a second layer over the first layer generating IR and comprised of a length of electrically-resistive material supported on a rectangular and non-conductive substrate, a third layer being an IR transmissive layer that is over the second layer.

21. The food holding oven of claim 19, wherein the crenellations of the rows adjacent to edges of the substrate are more numerous and closer to each other than are the crenellations of the rows away from the substrate edges.

22. The food holding oven of claim 19, wherein the planar infrared heater is comprised of eight parallel crenellated rows.

23. The food holding oven of claim 19, wherein the planar infrared energy source includes a UV-suppressive filter.

24. The food holding oven of claim 19, wherein the planar infrared energy source is a reduced UV heater.

25. A food holding oven comprising:
a base;
a food holding tray supported by said base, the food holding tray having four sides that extend above a perforated planar bottom;
a planar infrared energy source located above the food holding tray, the planar infrared energy source being comprised of a plurality of substantially rectangular planar layers, at least one layer emitting infrared energy toward the food holding tray such that the infrared energy emitted toward at least two lateral edges of the food holding tray is greater than the infrared energy emitted toward interior areas of the food holding tray; and
a UV-suppressive filter coupled to the planar infrared energy source.

26. The food holding oven of claim 25 wherein the plurality of rectangular layers are mechanically coupled together.

27. The food holding oven of claim 25 wherein the plurality of rectangular layers are bonded together with an adhesive.

28. A method of heating food in a tray in a food holding oven, the tray having at least three sides, the method comprising the steps of:
directing infrared energy downwardly toward the tray such that the amount of infrared energy per unit area directed along the sides of the tray is greater than the infrared energy per unit area that is directed to the interior of the tray.

29. The method of claim 16, wherein the infrared energy is emitted from electrically resistive material formed into a plurality of boustrophedonic rows.

30. The method of claim 16, wherein the infrared energy is emitted from electrically resistive material formed into a plurality of crenellated rows.
